(19) United States
(12) Patent Application Publication
(10) Pub. No.: US 2026/0104335 A1
(43) Pub. Date: Apr. 16, 2026

(54) AUTOMATED MECHANICAL LOAD TESTER FOR PV SYSTEMS AND METHODS

(71) Applicant: Unirac, Inc., Albuquerque, NM (US)

(72) Inventors: Ronald Gary Norman, Louisville, CO (US); Robert D'Anastasio, Albuquerque, NM (US); Joey Bacala, Cedar Crest, NM (US)

(21) Appl. No.: 18/914,579

(22) Filed: Oct. 14, 2024

(51) Int. Cl. G01N 3/04; H02S 50/10

(52) U.S. Cl. CPC G01N 3/04; H02S 50/10; G01N 2203/0206; G01N 2203/0282; G01N 2203/0411; G01N 2203/0417; G01N 2203/0476

(57) ABSTRACT

An apparatus for testing solar panel modules that includes a support frame, a test bed fixedly connected to the support frame and configured to connect with a solar panel module, and a load testing device mounted to the support frame. The load testing device includes a positioning device mounted to the support frame, an actuator hingedly fastened to the positioning device, and an arm having a first end rigidly fastened to the actuator and a second end opposite the first end. The arm extends away from the actuator. A load cell is fastened to the second end of the arm, and a universal joint is fastened to the load cell. A plate is hingedly connected to the universal joint, and a suction cup is rigidly engaged with the plate. A pneumatic system connection is incorporated within the actuator, and a vacuum system connection is incorporated within the suction cup.

### BACKGROUND

Photovoltaic (PV) components must be certified to comply with various certification standards (e.g., ANSI/NFPA 70, NEC, UL 2703, UL3741, etc.) to be sold and installed for use. To satisfy a particular certification standard, the PV component must endure a specified test to ensure that the component has the characteristics needed for the particular attribute being tested (e.g., localized tensile strength, strength to withstand up-force and/or down-force transients, etc.). Conventional methods to test for certification compliance require inefficient and repetitious weight transfer methods which may result in ergonomic injury to workers and unnecessarily expose workers to dangerous conditions. Additionally, conventional methods only allow for certification of one module at a time. To reduce the potential for ergonomic injury and increase the number of modules to be tested at once, new load-testing devices, systems, and methods are needed.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates an overhead front-side perspective view of an automated mechanical load tester for PV systems and methods.

FIG. 2 illustrates a front view of an automated mechanical load tester for PV systems and methods.

FIG. 3 illustrates a front view of a load testing component from an automated mechanical load tester for PV systems and methods.

FIG. 4 illustrates a top-front perspective view of an automated mechanical load tester for PV systems and methods.

### DETAILED DESCRIPTION

This disclosure is directed to an automated mechanical load tester for PV systems and methods. More specifically, this disclosure describes: embodiments of a mechanical load tester that may be used to simultaneously test multiple solar panel modules at once to satisfy a variety of regulatory requirements; embodiments of a mechanical load tester that may be used to simulate various extreme environmental conditions; embodiments of a mechanical load tester that may be used to conduct impact testing on a solar panel module; embodiments of a mechanical load tester that may be used to test solar panel modules for electrical safety; and embodiments of a mechanical load tester that may be used to determine the structural integrity of a solar panel module racking system and its components.

In an embodiment, the automated mechanical load tester may receive one or more solar panel modules on a solar panel test area (e.g., a test bed). The test bed may include racking componentry necessary to mount the one or more solar panel modules flat or at an angle relative to the mounting surface of the test bed (although it is not necessary for each solar panel module to be at the same angle) to simulate being mounted flat or at an angle on a pitched rooftop. Once mounted to the test bed, one or more load testing devices may be positioned over each solar panel module and lowered to allow the suction cups to adhere to the top surface of the solar panel module. The suction cups may draw a vacuum to attach themselves to the solar panel module, and the actuator in the load tester may push or pull on the mounted solar panel module to simulate various extreme conditions that a solar panel module may experience while mounted in various outdoor environments. In embodiments, force is applied to the solar panel in a direction perpendicular to the surface of the solar panel. While force is being applied to the solar panel modules, a load cell within the load testing device may measure the transient forces applied and transmit the data to a electronically connected monitoring device. It is understood that although racking componentry may be used to mount one or more solar panels at an angle, the racking componentry and the position of a load testing device relative to the solar panel module being tested may be adjusted to achieve a specific testing angle. For example, to test a solar panel module mounted on a roof pitched at a 45-degree angle, the racking componentry need not mount the solar panel module at 45-degrees relative to the test bed, rather the racking componentry may hold the panel at a certain angle and the load testing device may be positioned (e.g., via a height control system and/or angle control system) such that the testing device is applying pressure at a 45-degree angle relative to the surface of the solar panel module.

In an embodiment, a solar panel module may also be tested to determine its structural integrity during situations using a direct force tester wherein force is applied to a localized spot on the surface of the solar panel module (e.g., to simulate when a firefighter kneels on it during an emergency situation, etc.). In an embodiment, the direct force tester (e.g., localized load tester) may be integrated with the automated load tester. The direct force tester may include a foundation suitable for consistent and stable testing (e.g., a base mounted to the ground, a base mounted to a solid structure, etc.). In such an embodiment, the direct force tester may be positioned above the solar panel module installed on the test bed. The direct force tester may be adjusted to match the angle at which the solar panel module is mounted. Once in position, the direct force tester may utilize an actuator to lower a solar panel interaction device (e.g., a foot, suction cup, etc.) toward the solar panel module to engage with the solar panel module. In an embodiment, the direct force tester may utilize a height control system to bring the testing device closer to the solar panel module being tested, thereby allowing for an actuator to be sized accordingly. Attached to the foot is a ball and socket joint to allow the foot to fully engage with the surface of the solar panel module. Once the foot has engaged with the surface of the solar panel module at an appropriate angle, the actuator may apply a specific amount of force to the solar panel module through the foot. While force is being applied, a load cell may measure the force applied and transmit the data to a connected device.

In an embodiment, the direct force tester may be separate from the automated load tester. In such an embodiment, the direct force tester may include a test bed area that includes componentry capable of mounting a solar panel module either flat or at an angle to match the installation angle of the module on a pitched roof. In such an embodiment, the direct load test may also include a frame (e.g., a testing frame) that may be used to position the direct force tester over the solar panel module being tested. The testing frame may be adjusted such that the direct force tester may be positioned at an angle to match the angle at which the solar panel module is mounted. Once in position, the direct force tester may utilize an actuator to lower a foot toward the solar panel module to engage with the solar panel module. Attached to the foot is a ball and socket joint to allow the foot to fully engage with the surface of the solar panel module. Once the foot has engaged with the surface of the solar panel module at an appropriate angle, the actuator may apply a specific amount of force to the solar panel module through the foot. While force is being applied, a load cell may measure the force applied and transmit the data to a connected device.

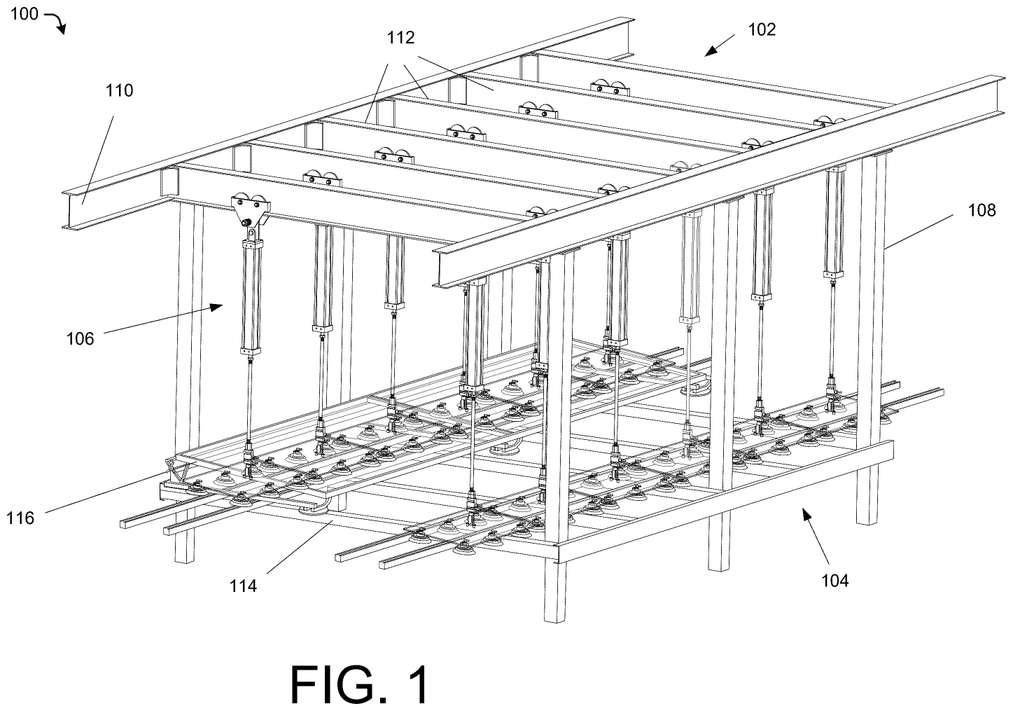

FIG. 1 illustrates an overhead front-side view of an automated mechanical load tester 100 (hereinafter “load tester 100”). In an embodiment, the load tester 100 may include a support frame 102, test bed 104, and load testing device 106. In an embodiment, the support frame 102 may include one or more support beam(s) 108, one or more support rail(s) 110, and one or more load tester rail(s) 112.

In an embodiment, the support beams 108 may be arranged at various distances to outline a predetermined geometric shape. For example, an embodiment may include four support beams 108 that are arranged to outline the four corners of a square. In another example, an embodiment may include six support beams 108 that are arranged to outline a rectangle with four of the support beams 108 in the corners and the remaining two support beams 108 being in the midpoints of the longest spaces between the four corner beams.

As used herein, the term “support beam” may include hollow, solid, or semi-solid, tubular shapes, having cross-sections that are comparable to geometrical shapes. For example, a support beam 108 may be cylindrically shaped and have a circular cross-section. As another example, the support beam 108 may have a square prism shape and a square-shaped cross-section. It is understood that the support beams may be made of concrete, metal, or other suitable material.

In an embodiment, the support rails 110 may be attached to the support beams 108 such that the support rails 110 outline the geometric shape that the support beams 108 may form. For example, if the support beams 108 are arranged to represent the four corners of a square, the support rails 110 may be attached to the upper portions and/or lower portions of the support beams 108 to create an outline that may resemble a square. It is understood that the support rails 110 do not have to outline any particular shape. For example, if four support beams 108 are oriented such that the support beams 108 create four corners of a square, a first group of four support rails 110 may be attached around the perimeter of the support beams 108 to outline a square while a pair of support rails 110 may be diagonally attached from one support beam 108 to another such that an X-shape is created. It is understood that the support rails 110 may be constructed from metallic or other suitable materials.

As used herein, the term “test bed rail” may include hollow, solid, or semi-solid, tubular shapes, having cross-sections with varying shapes. For example, a test bed rail 114 may be cylindrically shaped and have a circular cross-section. As another example, a test bed rail may have a square prism shape and a square-shaped cross-section, other shape entirely. It is understood that the test bed rails 114 may be made of plastic material, composite material, metallic material, or other suitable material. In an embodiment, a test bed rail 114 may be made of a first material and have a portion of the test bed rail 114 covered by a second material. For example, the test bed rail 114 may be metallic and have plastic material oriented on the portion of the test bed rail 114 that may come in contact with the solar panel module 116.

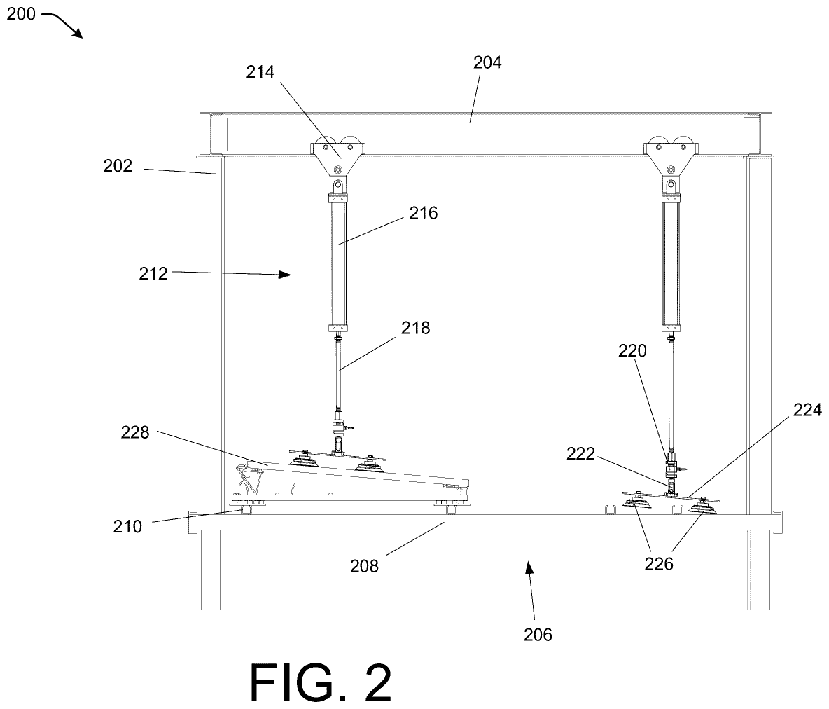

FIG. 2 depicts a front view of the automated mechanical load tester 200 (hereinafter “load tester 200”). In an embodiment, load tester 200 may include support beam 202, load tester rail 204, test bed 206, test bed rail 208, test bed bracketry 210, and load testing device 212. In an embodiment, load testing device 212 may include positioning device 214, actuator 216, arm 218, load cell 220, universal joint 222, plate 224, suction cup 226, and solar panel module 228.

In an embodiment, the load-tester rail 204 may be one of many load tester rails arranged horizontally and parallel to one another to create a platform. In an embodiment, the load tester rail 204 may be configured to attach to a positioning device 214 of a load testing device 212 such that the positioning device 214 may be repositioned along the load tester rail 204 (e.g., positioning device 214 may include one or more rollers resting on one or more outside surfaces of the load tester rail 204 and configured to allow relative motion between the positioning device 214 and the load tester rail 204). In an embodiment, the load tester rail 204 may resemble an I-beam. In an embodiment, load tester rail 204 may be metallic or made from other suitable material(s).

In an embodiment, the test bed 206 may include test bed bracketry 210 and one or more testbed rail(s) 208. In an embodiment, the test bed bracketry 210 may include racking components configured to mount a solar panel module 228 at an angle. In an embodiment, the test bed rail 208 may be one of many that may be arranged horizontally and parallel to one another to create a platform. In embodiments, test bed rail(s) 208 may be arranged in a manner that enables simulation of the spacings of attachments that would support the structure (e.g., rail, etc.) supporting the solar panel module. In embodiments, using the test bed rail(s) 208 to simulate support attachments may allow the mechanical load tester to test a photovoltaic support system, including a solar panel module in a configuration that may replicate a rooftop.

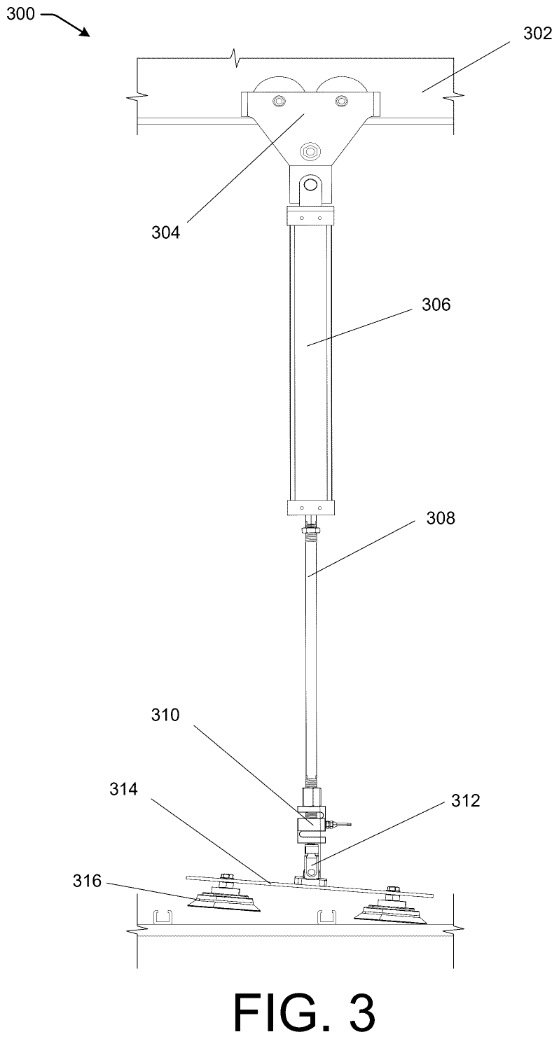

FIG. 3 depicts a front view of load testing device 300. In an embodiment, load testing device 300 may include load tester rail 302, positioning device 304, pneumatic actuator 306, arm 308, load cell 310, universal joint 312, plate 314, and suction cup 316.

In an embodiment, load testing device 300 may include a positioning device 304, a pneumatic actuator 306, an arm 308, a load cell 310, a universal joint 312, a plate 314, and a suction cup 316.

In an embodiment, the positioning device 304 may be configured to attach to a load tester rail 302. In an embodiment, the positioning device 304 may be positionable and re-positionable along a load tester rail 302. For example, the load tester rail 302 may resemble an I-beam. Following that example, the positioning device 304 may resemble a trolley that is configured for rolling along the length of the I-beam.

In an embodiment, the pneumatic actuator 306 may be a single-acting (fail open or fail closed) or a double-acting linear pneumatic actuator. It is understood that the operational capabilities of the pneumatic actuator 306 may vary based on the specific embodiment. In an embodiment, the pneumatic actuator 306 may apply force to the arm 308 to cause the arm 308 to extend or retract.

In an embodiment, the arm 308 may be connected to the load cell 310. In an embodiment, the load cell 310 may be configured to measure an application of force (e.g., an s-beam load cell, a strain gauge load cell, etc.) and transmit the measured force to a monitoring device. The load cell 310 may be electronically connected to a monitoring device (e.g. a computer, etc.) configured to analyze and record the data received by the load cell.

In an embodiment, the universal joint 312 may be configured to allow the plate 314 to tilt such that the plate 314 may match the angle of a solar panel module. Although depicted in this disclosure as having a rectangular shape, the plate 314 may be any geometrical shape useful for the specific embodiment. For example, when load testing a rectangular-shaped solar panel module, the plate 314 may be rectangular. However, it is contemplated that the shape of the plate 314 need not be the same as the shape of the component being tested. For example, a square-shaped plate 314 may be used while testing a rectangularly-shaped solar panel module.

In an embodiment, a load testing device 300 may include one or more suction cup(s) 316. The suction cups 316 may vary in size based on the desired application. In an embodiment, the suction cups 316 may have a textured surface to create friction. For example, in an embodiment wherein applying downforce through a suction cup 316 onto a solar panel module that is at a non-zero angle, the suction cups 316 having a textured surface, will not slide. In an embodiment, the suction cups 316 may be made of rubber or another suitable material.

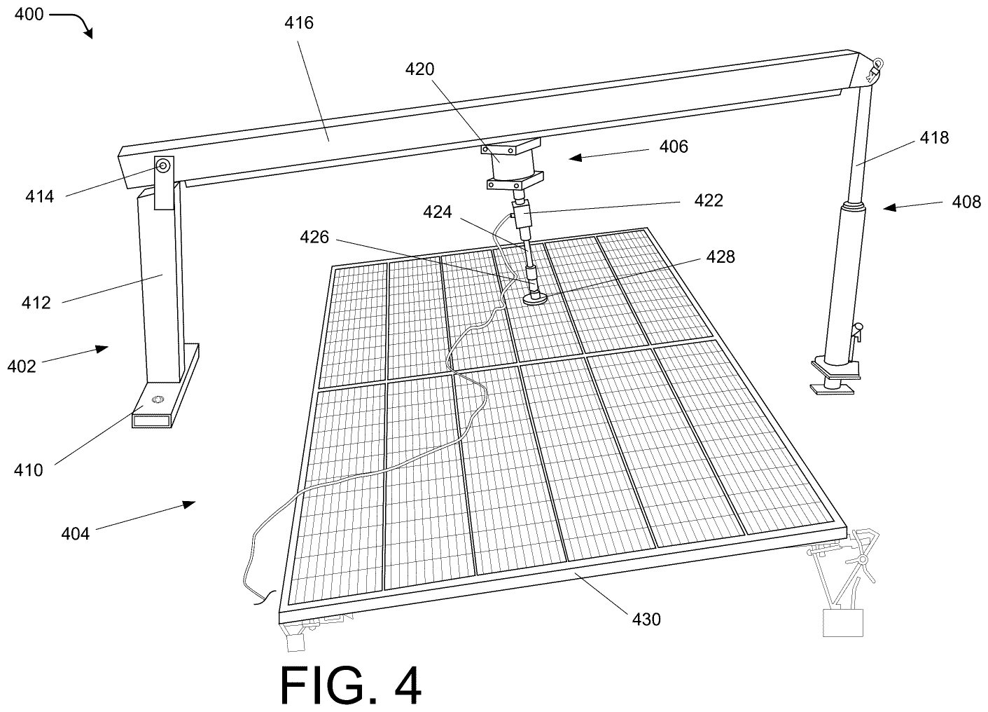

FIG. 4 depicts a front view of a direct force tester 400. In an embodiment, the direct force tester 400 may include a frame 402, a solar panel test area 404, a load testing device 406, and a height control system 408. In an embodiment, the frame 402 may include a base 410, a post 412, a hinge 414, and an arm 416. In embodiments, the load testing device 406 may be slidably connected the arm 416 (e.g., the load testing device 406 may be positioned along the arm 416 closer to the hinge 414 and repositioned along the arm 416 closer to the height control system 408). The load testing device 406 may include an actuator 420, load cell 422, a shaft 424, a ball and socket joint 426, and a foot 428. Although the height control system 408 is depicted in FIG. 4 as a gas cylinder 418, it is understood that the height control system 408 may be any system or device capable of raising and lowering the arm 416 (e.g., an overhead crane, a pneumatic actuator, etc.).

In an embodiment, the base 410 may be installed on a portion of an automated mechanical load tester (e.g., load tester 100, load tester 200, load testing device 300, etc.). In an embodiment, the base 410 may be mounted to the ground. While FIG. 4 depicts the base 410 as being rectangular, it is understood that base 410 may have any shape. While FIG. 4 depicts using bolts to fasten the base 410 to the ground, it is understood that the base 410 may be fastened to the ground utilizing any fastening method that provides an adequate anchor for the direct force tester 400.

As used herein, the terms “post” and/or “arm” may include hollow, solid, or semi-solid, tubular shapes, having cross-sections that are comparable to geometrical shapes, as just some examples. For example, a post 412 may be cylindrically shaped and have a circular cross-section. As another example, the arm 416 may be square prism-shaped and have a square-shaped cross-section. Although depicted in FIG. 4 as having the same shape, post 412 and arm 416 need not have the same shape. For example, post 412 may be cylindrically shaped while arm 416 is square prismed shaped. It is understood that the support beams may be made of metallic or other suitable material.

In an embodiment, the hinge 414 may be one of many varieties of known hinges (e.g., a counterbalanced hinge, a spring-assist hinge, a butt hinge, a piano hinge, etc.). In an embodiment, the hinge 414 may be configured to attach the post 412 with the arm 416. A first end of arm 416 may attach to the post 412 via the hinge 414, and a second end of arm 416 may attach to the gas cylinder 418 of the height control system 408. The second end of arm 416 may attach to the gas cylinder 418 of the height control system 408 via a pin, a bolt, or other reasonable fastener to allow for the arm 416 to maintain its attachment to the gas cylinder 418 of the height control system 408 while being raised or lowered.

In an embodiment, the actuator 420 may be connected to the load cell 422. In an embodiment, the load cell 422 may be of the type configured to measure an application of force (e.g., an s-beam load cell, a strain gauge load cell, etc.) and/or displacement of force.

In an embodiment, the actuator 420 may be a single-acting (fail open or fail closed) or a double-acting linear pneumatic actuator. It is understood that the operational capabilities of the actuator 420 may vary based on the specific embodiment. In an embodiment, the actuator 420 may apply force to the shaft 424 to cause the shaft 424 to extend or retract. In embodiments, the actuator may also be adjusted along arm 416 by using strut or any type of channel.

In an embodiment, the ball and socket joint 426 may be configured to allow the foot 428 to tilt such that the foot 428 may match the angle of the solar panel module 430. Although depicted in FIG. 4 as having a round shape, it is understood that the foot 428 may have any desired geometric shape.

In an embodiment, the height control system 408 may be fastened to an end of the arm 416 opposite the hinge 414. In an embodiment, the height control system 408 may raise or lower the arm 416 such that the arm 416 pivots at hinge 414 to adjust the angle of arm 416. In an embodiment, the height control system 408 may be adjusted such that the angle of arm 416 matches the angle at which the solar panel module 430 is mounted.

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. An apparatus comprising:
a support frame;
a test bed fixedly connected to the support frame and configured to connect with a solar panel module such that a main surface plane of the solar panel module is oriented at an angle with respect to a horizontal plane;
a load testing device mounted to the support frame, the load testing device including:
a positioning device mounted to a portion of the support frame,
an actuator hingedly fastened to the positioning device,
an arm having a first end rigidly fastened to the actuator and a second end opposite the first end, the arm extending in a direction away from the actuator,
a load cell fastened to the second end of the arm,
a universal joint fastened to the load cell,
a plate hingedly connected to the universal joint, and
a suction cup mounted to the plate;
a pneumatic system connection incorporated within the actuator; and
a vacuum system connection incorporated within the suction cup.

2. The apparatus according to claim 1, wherein the support frame includes:
a first support beam,
a second support beam separated from the first support beam by a first distance in a first direction,
a third support beam separated from the second support beam by a second distance in a second direction extending away from the first direction,
a fourth support beam that is separated from the third support beam by a third distance in a third direction extending away from the second direction, the fourth support beam also separated from the first support beam by a fourth distance in a fourth direction extending away from the third direction,
a first support rail attached to an upper portion of the first support beam at a first end and attached to an upper portion of the second support beam at a second end that extends in a fifth direction, and
a second support rail attached to an upper portion of the third support beam at a first end and attached to an upper portion of the fourth support beam at a second end that extends in a sixth direction that is parallel to the fifth direction.

3. The apparatus according to claim 2, wherein:
the solar panel module is a first solar panel module,
the angle is a first angle, and
the test bed includes:
a first test bed rail attached to a lower portion of the first support beam at a first end and attached to a lower portion of the fourth support beam at a second end,
a second test bed rail attached to a lower portion of the second support beam at a first end and attached to a lower portion of the third support beam, and
the test bed is configured to connect with the first solar panel module at the first angle and a second solar panel module at a second angle.

4. The apparatus according to claim 1, wherein, when implemented for testing a mechanical load:
a pneumatic system is configured to adjust air pressure within the actuator via the pneumatic system connection,
a vacuum system is configured to adjust air pressure within the suction cup via the vacuum system connection,
the suction cup, utilizing the vacuum system, is engaged with the solar panel module via vacuum pressure, and
the actuator, utilizing the pneumatic system, is configured to retract the arm in a second direction that is away from the test bed.

5. The apparatus according to claim 1, wherein, when implemented for testing a mechanical load:
a pneumatic system is configured to adjust air pressure within the actuator via the pneumatic system connection,
the suction cup is configured to adjust air pressure within the solar panel module, and
the actuator, utilizing the pneumatic system, is configured to extend the arm in a second direction that is toward the test bed.

6. The apparatus according to claim 1, wherein:
the portion of the support frame includes a load tester rail, and
the positioning device is a trolley configured to be positionable along a length of the load tester rail.

7. The apparatus according to claim 1, wherein the load cell is configured to measure transient forces and is electronically connected to a monitoring device.

8. A load tester comprising:
a foundation extending in a first direction;
an arm having a first end hingedly connected to the foundation and extending in a second direction away from the first direction and a second end opposite the first end;
a height control system fastened to the second end of the arm; and
a load testing device.

9. The load tester according to claim 8, wherein the foundation includes:
a base; and
a post having a first end extending from the base and extending in a first direction away from the base and a second end opposite the first end, the second end having a hinge.

10. The load tester according to claim 8, wherein the load testing device includes:
an actuator including a pneumatic system connection, the actuator slidably attached to a middle portion of the arm;
a load cell attached to the actuator;
a shaft having a first end attached to the load cell and a second end opposite the first end, the shaft extending in a third direction away from the second direction;
a universal joint attached to the second end of the shaft; and
a surface contact device attached to the universal joint.

11. The load tester according to claim 10, wherein:
a pneumatic system configured to adjust air pressure within the actuator via the pneumatic system connection; and
the actuator, utilizing the pneumatic system, retracts the shaft in a second direction that is away from a test bed.

12. The load tester according to claim 10, wherein the load cell is configured to measure transient forces and is electronically connected to a monitoring device.

13. The load tester according to claim 10, wherein the surface contact device has a round shape and is formed of rubber.

14. The load tester according to claim 10, wherein the universal joint is a ball and socket joint.

15. A load tester for solar panel modules, the load tester comprising:
a frame;
a solar panel test area adjacent to the frame;
a load testing device disposed above the solar panel test area, the load testing device including:
an actuator,
a load cell connected to the actuator,
a solar panel interaction device hingedly connected to the load cell, and
a pneumatic system connection incorporated within the actuator; and
a height control system configured to adjust a height of the load testing device relative to the solar panel test area.

16. The load tester for solar panel modules of claim 15, further comprising:
a pneumatic system configured to adjust air pressure within the actuator via the pneumatic system connection,
wherein the actuator, utilizing the pneumatic system, adjusts a proximity of the solar panel interaction device with respect to the solar panel test area.

17. The load tester for solar panel modules of claim 15, wherein the load cell is configured to measure transient forces and is electronically connected to a monitoring device.

18. The load tester for solar panel modules of claim 15, wherein the load testing device is a first load testing device, and
wherein the load tester for solar panel modules further comprises a second load testing device.

19. The load tester for solar panel modules of claim 15, wherein the solar panel test area is configured to position a solar panel at a variety of angles relative to the load testing device.

20. The load tester for solar panel modules of claim 15, wherein the solar panel test area is configured to mount at least two solar panel modules.
